(19) United States
(12) Patent Application Publication
(10) Pub. No.: US 2012/0285724 A1
(43) Pub. Date: Nov. 15, 2012

(54) INSULATED WIRE

(76) Inventors: Makoto OYA, Tokyo (JP); Daisuke Muto, Tokyo (JP)

(21) Appl. No.: 13/556,902

(22) Filed: Jul. 24, 2012

Related U.S. Application Data
(63) Continuation of application No. PCT/JP2011/072683, filed on Sep. 30, 2011.

(30) Foreign Application Priority Data
Oct. 1, 2010 (JP) 2010-224337

(51) Int. Cl. H01B 7/00

(52) U.S. Cl. 174/120 C

(57) ABSTRACT

{Problems} To provide an insulated wire, which is high in a dielectric breakdown resistance even if insulating resin coatings are laminated, because the interlayer adhesiveness is excellent, and which is excellent in a partial discharge resistance, because the dielectric constant is low.

{Means to solve} An insulated wire, having directly or indirectly on a conductor (1), at least two laminate units each formed by laminating an insulating layer (21,23) and an insulating layer (22, 24) higher in a dielectric constant than the insulating layer (21, 23), in this order from the conductor side.

### TECHNICAL FIELD

The present invention relates to an insulated wire.

### BACKGROUND ART

Inverters have become installed in many types of electrical equipments, as efficient variable-speed control units. However, inverters are switched at a frequency of several kHz to several ten kHz, to cause a surge voltage at every pulse thereof. Such an inverter surge is a phenomenon in which reflection occurs at a breakpoint of impedance, for example, at a starting end, a termination end, or the like of a connected wire in the propagation system, and consequently, to apply a voltage twice as high as the inverter output voltage at the maximum. In particular, an output pulse occurred due to a high-speed switching device, such as an IGBT, is high in steep voltage rise. Accordingly, even if a connection cable is short, the surge voltage is high, and voltage decay due to the connection cable is also low. As a result, a voltage almost twice as high as the inverter output voltage occurs.

As coils for electrical equipments, such as inverter-related equipments, for example, high-speed switching devices, inverter motors, and transformers, use is made of insulated wires, which are mainly enameled wires, as magnet wires in the coils. Further, as described above, since a voltage almost twice as high as the inverter output voltage is applied to in inverter-related equipments, it becomes required in insulated wires to have minimized partial discharge deterioration due to the inverter surge.

In order to prevent deterioration of insulated wires caused by such a partial discharge, an investigation is conducted on insulated wires high in a partial discharge occurring voltage. In order to obtain such an insulated wire, such measures are studied as increasing the thickness of an insulating layer of the insulated wire, or using a resin low in a dielectric constant in the insulating layer.

However, when the thickness of the insulating layer is increased, the resultant insulated wire becomes thicker, and as a result, size enlargement of electrical equipments is brought about. This is retrograde to the demand in recent miniaturization of electrical equipments represented by motors and transformers. For example, specifically, it is no exaggeration to say that the performance of a rotator, such as a motor, is determined by how many electrical wires are held in a cross section of a stator slot. As a result, the ratio (space factor) of the sectional area of conductors to the sectional area of the stator slot, has been highly increased in recent years. Thus, if the thickness of the insulating layer is increased, the space factor is lowered, which is not preferable.

On the other hand, as an insulated wire having an insulating layer low in a dielectric constant, there is a proposal of an insulated wire obtained by applying, on a conductor, a coating of a polyimide resin having a fluorine atom or a perfluoroalkyl group at a specific site in the molecule (see, for example, Patent Literature 1). However, in a conventional insulated wire, an insulating layer is formed by repeatedly applying, on a conductor, a coating containing a solvent multiple times, followed by drying. The polyimide resin described in the Patent Literature 1 is insufficient in the interlayer adhesive force. If the interlayer adhesive force of the resin coating formed on a conductor is insufficient, when the insulated wire is processed, delamination or peeling off between layers occurs in some extreme cases, and the insulated wire cannot be used. Even in the case where obvious delamination does not occur, the insulated wire is low in the dielectric breakdown voltage and has a problem with electrical insulating property in many cases. Furthermore, there is a problem that when the temperature rises, a corrosive gas including hydrogen fluoride is generated, and consequently, early deterioration may occur in metal parts of the equipments in use.

In addition to the above, as an insulated wire having an insulating layer low in a dielectric constant, there is another proposal of an insulated wire using a polyamideimide resin coating in which the number of amido groups and the number of imido groups per repeating unit are reduced (see, for example, Patent Literature 2). In the case of this insulated wire, since the number of amido groups and the number of imido groups are reduced, the adhesive force to the conductor is not sufficient. In regard to the adhesive force to the conductor, when processing such as bending or stretching is carried out, detachment or peeling off occurs between the conductor and the insulating layer, to cause a problem in electrical insulating property in many cases. Also, the raw materials to be used are special materials and are highly expensive.

There is still another proposal of an insulated wire, which has a processing resistance by which no damage is caused in the layer even if the wire is subjected to severe rolling, coil-winding, or the like, which a high heat resistance that is equivalent to that of polyamideimide, and which has a bonding property by which the insulating layer in the vicinity of a bonded region does not undergo foaming under the heat of bonding or the like, upon the process of bonding the terminal of the insulated wire (see, for example, Patent Literature 3). In this insulated wire described in Patent Literature 3, (1) a first insulating layer substantially composed of at least one of a polyamideimide and a polyimide, and (2) a second insulating layer composed of a polyamideimide A and a thermoplastic resin B with glass transition temperature 140° C. or higher, by blending those at a proportion, as expressed in the weight ratio A/B, of A/B=70/30 to 30/70, are coated and laminated in this order, and thereby the insulating layers are formed, on a conductor, in which the ratio T₁/T₂ between the thickness of the first insulating layer T₁ and the thickness of the second insulating layer T₂ is in the range of T₁/T₂=5/95 to 40/60, and the residual solvent amount is 0.05% by weight or less to the total amount of the insulating layers. In the insulated wire described in Patent Literature 3, the heat resistance as evaluated by the thermal softening temperature is 400° C. or higher. However, there is no mention on the dielectric constant of the respective layer in the two-layered laminate structure of the first insulating layer and the second insulating layer, and there is a problem that the dielectric breakdown strength is low.

### CITATION LIST

### Patent Literatures

Patent Literature 1: JP-A-2002-56720 (“JP-A” means unexamined published Japanese patent application)
Patent Literature 2: JP-A-2009-161683
Patent Literature 3: JP-A-2001-155551

### SUMMARY OF INVENTION

### Technical Problem

The present invention is contemplated for providing an insulated wire having at least two laminate units, each of which laminate unit is formed by laminating a layer low in a dielectric constant and a layer high in a dielectric constant, which insulated wire is high in a dielectric breakdown voltage, and which insulated wire does not cause any increase in the dielectric constant, despite including the layer high in a dielectric constant, as compared with insulated wires having a single layer formed by blending a material low in a dielectric constant with a material high in a dielectric constant.

### Solution to Problem

In view of the problems above, the inventors of the present invention, having studied keenly, have found that an insulated wire, in which an insulating layer high in a dielectric constant and an insulating layer low in a dielectric constant are repeatedly formed multiple times on a conductor, does not cause any increase in the dielectric constant, as compared with insulated wires having a single layer formed by blending a material low in a dielectric constant with a material high in a dielectric constant, in spite of including the layer high in a dielectric constant, and that the insulated wire has a high dielectric breakdown voltage. Thus, the present invention was attained based on this finding.

According to the present invention, there is provided the following means:

<1> An insulated wire, having directly or indirectly on a conductor, at least two laminate units each formed by laminating a first insulating layer (X1) and a second insulating layer (X2) higher in a dielectric constant than the first insulating layer (X1), in this order from the conductor side.
<2> The insulated wire as described in item <1>, in which the dielectric constant (∈(X2)) of the second insulating layer (X2) in one laminate unit is higher than the dielectric constant (∈(X1′)) of the first insulating layer (X1′) in another laminate unit that is positioned on the outer layer side of the one laminate unit.
<3> The insulated wire as described in item <1> or <2>, in which an absolute value of a difference between the dielectric constants of two layers that are in contact with each other among the insulating layers is 0.2 or greater.
<4> The insulated wire as described in any one of items <1> to <3>, in which the first insulating layers (X1, X1′, . . . ) low in a dielectric constant in the respective laminate units each are composed of a resin composition containing at least one selected from the group consisting of a polyetherimide, a polyethersulfone, a polyphenyleneether, a polyphenylsulfone, and a polyimide.
<5> The insulated wire as described in any one of items <1> to <3>, in which the first insulating layers (X1, X1′, . . . ) low in a dielectric constant in the respective laminate units each are composed of a resin composition containing at least one selected from the group consisting of a polyetherimide, a polyethersulfone, a polyphenyleneether, a polyphenylsulfone, and a polyimide, and further containing a polyamideimide.
<6> The insulated wire as described in item <4> or <5>, in which the second insulating layers (X2, X2′, . . . ) high in a dielectric constant in the respective laminate units each are composed of a resin composition containing a polyamideimide.
<7> The insulated wire as described in item <4> or <5>, in which the second insulating layers (X2, X2′, . . . ) high in a dielectric constant in the respective laminate units each are composed of a resin composition containing a polyamideimide, and further containing at least one selected from the group consisting of a polyetherimide, a polyethersulfone, a polyphenyleneether, a polyphenylsulfone, and a polyimide.

Herein, in the present specification, the “second insulating layer higher in a dielectric constant than the first insulating layer” as described above may be simply referred to as the “second insulating layer high in a dielectric constant” or “insulating layer high in a dielectric constant”, and with respect to this relationship, the “first insulating layer lower in a dielectric constant than the second insulating layer” may be simply referred to as the “first insulating layer low in a dielectric constant” or “insulating layer low in a dielectric constant”, respectively.

### Advantageous Effects of Invention

According to the present invention, an insulated wire can be provided, which is high in a dielectric breakdown resistance even if insulating resin coatings are laminated, because the interlayer adhesiveness is excellent, and which is excellent in a partial discharge resistance, because the dielectric constant is low.

Other and further features and advantages of the invention will appear more fully from the following description, appropriately referring to the accompanying drawings.

### BRIEF DESCRIPTION OF THE DRAWINGS

FIG. 1 is a cross-sectional view schematically showing an embodiment of the insulated wire of the present invention.

FIG. 2(a) is a cross-sectional view schematically showing a part of an embodiment of the insulated wire of the present invention; FIG. 2(b) is a cross-sectional view schematically showing a part of another embodiment of the insulated wire of the present invention; and FIG. 2(c) is a cross-sectional view schematically showing a part of still another embodiment of the insulated wire of the present invention.

### MODE FOR CARRYING OUT THE INVENTION

Hereinafter, embodiments of the insulated wire of the present invention will be described with reference to the drawings.

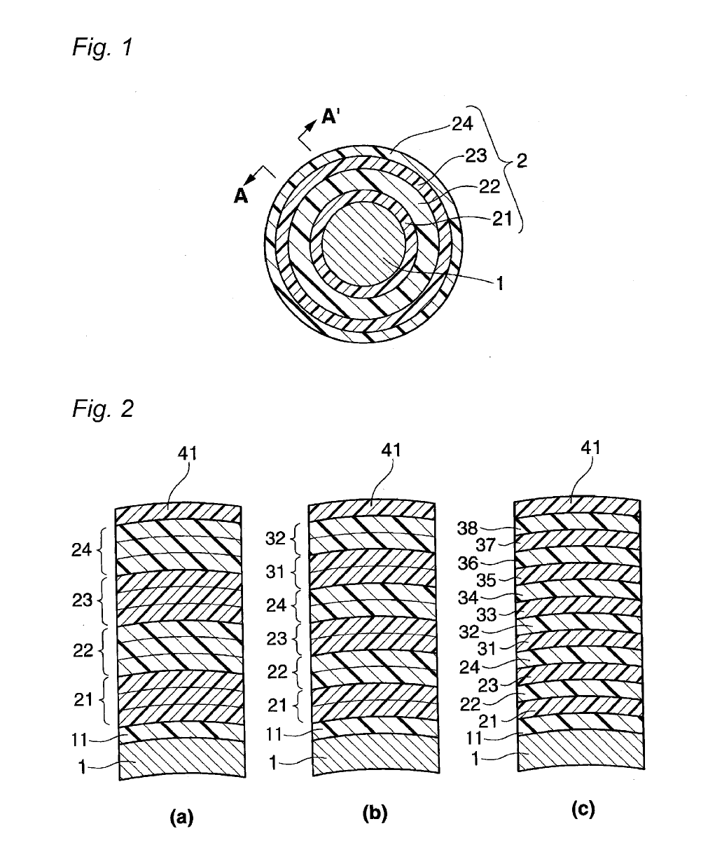

An embodiment of the insulated wire of the present invention, as shown in the cross-sectional view in FIG. 1, has a conductor 1, and insulating layers 2 covering the conductor 1. The insulated wire of the present invention has, directly or indirectly on the conductor, at least two laminate units each formed by laminating an insulating layer (X1) and an insulating layer (X2) higher in a dielectric constant than the insulating layer (X1), in this order from the conductor side. FIG. 1 shows the insulated wire having the insulating layers directly on the conductor, but as will be described below, the insulated wire may have the insulating layers on the conductor, with an adherent layer (not shown in FIG. 1) interposed therebetween. Furthermore, the insulated wire may also have a topcoat (not shown in FIG. 1), such as a surface lubricating layer or an abrasion resistant layer, at the top surface layer of the insulating layers. FIG. 2(a) to FIG. 2(c) each show a part of the partially-enlarged view of section A-A′, as shown in FIG. 1, in an insulated wire having an adherent layer and a topcoat.

In the present specification, a lamination, which is formed by laminating the insulating layer (X1) and the insulating layer (X2) higher in a dielectric constant than the insulating layer (X1), is called a laminate unit. Thus, examples of an insulated wire having at least two laminate units include the insulated wire, as shown in FIG. 1, in which an insulating layer 21 (X1) is formed, an insulating layer 22 (X2) higher in a dielectric constant than the insulating layer 21 (X1) is laminated thereon, to form a first laminate unit, an insulating layer 23 (X1′) low in a dielectric constant is laminated on the first laminate unit, and an insulating layer 24 (X′2) higher in a dielectric constant than the insulating layer 23 (X1′) is laminated thereon, to form a second laminate unit.

More preferably, it is preferable that the dielectric constants of the insulating layer 22 (X2) high in a dielectric constant in a first laminate unit and the insulating layer 23 (X1′) low in a dielectric constant that belongs to a second laminate unit other than the first laminate unit, are represented by formula (1):

∈(X2)>∈(X1′) Formula (1)

In formula (1), ∈(X2) represents a dielectric constant of the insulating layer (X2), and ∈(X1′) represents a dielectric constant of the insulating layer (X1′).

Herein, the relationship expressed by formula (1) is not limited to the case where the relationship is satisfied between two adjacent laminate units such as exemplified above, and including this embodiment, as defined in the item <2>, the relationship may be satisfied between particular two laminate units that are not necessarily adjacent to each other.

Based on this, the insulated wire of the present invention has at least two or more laminate units in which an insulating layer low in a dielectric constant and an insulating layer higher in a dielectric constant than the insulating layer are alternately laminated, in this order from the conductor side.

The conductor 1 is made of, for example, copper, a copper alloy, aluminum, an aluminum alloy, or a combination thereof. The cross-sectional shape of the conductor 1 is not limited, and a circular shape, a rectangular shape (perpendicular shape), and the like can be applied.

The size (in the case of a circular cross-sectional shape, the diameter; or in the case of a rectangular cross-sectional shape, the length of the longer side) of the conductor 1 can be appropriately set, but the size may be set to 0.05 to 5 mm. More preferably, the size is 0.1 to 4 mm.

The thickness of the insulating layers 2 may be appropriately set, but the thickness may be set to 20 to 200 μm as the sum of the insulating layers 21 to 24. More preferably, the thickness is 30 to 150 μm.

As shown in FIG. 1, the insulated wire of the present invention has the insulating layer 21 (X1), and the insulating layer 22 (X2) higher in a dielectric constant than the insulating layer 21 (X1), formed on the conductor, and more preferably, the insulating layer 23 (X1′) lower in a dielectric constant than the insulating layer 22 (X2) is formed on the insulating layer 22 (X2), and the insulating layer 24 (X2′) higher in a dielectric constant than the insulating layer 23 (X1′) is formed on the insulating layer 23 (X1′). On the insulating layer 24 (X2′), another laminate unit(s) may be laminated to stack, to constitute the insulated to have three or more laminate units. The dielectric constant can be measured with a commercially available measuring instrument. The measurement temperature and the measurement frequency can be modified as necessary, but unless otherwise specified in the present specification, the dielectric constant refers to the value obtained by setting the measurement temperature to 25° C. and the measurement frequency to 50 Hz. The dielectric constant of each insulating layer refers to the value measured after drying the resin composition coating constituting the insulating layer, and volatilizing the solvent contained in the coating.

The absolute value of the difference between the dielectric constants of two layers that are in contact with each other among the insulating layers, is preferably 0.2 or greater, and more preferably 0.3 to 1.8. Furthermore, the difference between the dielectric constants of two insulating layers that are in contact with each other in each laminate unit is preferably that the difference between the dielectric constant of the insulating layer that is an outer layer (on the side apart from the conductor) high in a dielectric constant and the dielectric constant of the insulating that is an inner layer (on the side close to the conductor) low in a dielectric constant, be 0.2 or greater, and more preferably, this difference is 0.3 to 1.8. If the difference of the dielectric constants is too small, an insulated wire low in a dielectric constant may not be obtained. On the other hand, if the difference of the dielectric constants is too large, the dielectric constant of X2 is consequently raised up, and the dielectric constant of the layers as a whole may not be lowered.

The insulating layers of the insulated wire of the present invention can be formed directly or indirectly on the conductor. For example, as shown in FIG. 2(a), the respective insulating layers 21 to 24 can be formed by repeatedly applying the resin compositions constituting the insulating layers, appropriately drying the resin compositions, and thereby laminating the insulating layers. As such, the insulating layer 21 may be directly formed on the conductor, but an adherent layer 11 excellent in adhesiveness to the conductor may be formed between the conductor 1 and the insulating layer 21 of the lowermost layer (closest to the conductor). Examples of a material that can be used for the adherent layer include a polyimide, a polyurethane, a polyamideimide, a polyester, a polyesterimide, a melamine resin, and an epoxy resin. Since these resins each are generally high in a dielectric constant, a layer formed on the adherent layer, which does not include the adherent layer, is designated as the insulating layer 21. To any of these resins for the adherent layer, an adhesion-improving agent may be added, for example, a silane alkoxide-based adhesion-improving agent (silane coupling agent); a titanium-based adhesion-improving agent, such as a titanium alkoxide, a titanium acylate, and a titanium chelate; a triazine-based adhesion-improving agent; an imidazole-based adhesion-improving agent; a melamine-based adhesion-improving agent; and a thiol-based adhesion-improving agent.

In the respective insulating layers 21 to 24, by laminating a layer low in a dielectric constant and a layer high in a dielectric constant, an insulated wire high in the dielectric breakdown voltage can be obtained, despite of that the insulated wire contains the layer high in a dielectric constant, without increasing the dielectric constant as compared with insulated wires having a single layer formed by blending a material low in a dielectric constant with a material high in a dielectric constant. Although the reason is not clarified yet, it is presumed that it is because the dielectric constant is determined by the volume of each material per volume. Furthermore, the insulated wire of the present invention has a high dielectric breakdown voltage and is excellent in the electrical insulating property. Conventionally, an insulated wire which uses a resin low in a dielectric constant, for example, a polyetherimide or a polyethersulfone, singly in the insulating layer, certainly is low in a dielectric constant, but is also low in a dielectric breakdown voltage. On the contrary, the insulated wire of the present invention can have a high dielectric breakdown voltage, without increasing the dielectric constant as compared with insulated wires having a single layer produced by mixing a material low in a dielectric constant with a material high in a dielectric constant, despite of that the insulated wire includes the layer high in a dielectric constant, by providing, for example, of a plurality of laminations of the layers with a resin low in a dielectric constant and the layers with a resin high in a dielectric constant.

The insulated wire of the present invention is preferably that the dielectric constant of the layers as a whole be 3.9 or less, and more preferably 3.8 or less. The lower limit of the dielectric constant of the layers as a whole is not particularly limited, but the lower limit is generally 2.5 or greater, and preferably 3.0 or greater. Herein, the layers as a whole refers to the entirety combining the adherent layer (primer layer) as described above, the insulating layers each having a low dielectric constant, the insulating layers each having a higher dielectric constant than the aforesaid insulating layers, and the topcoat, such as a surface lubricating layer and an abrasion resistant layer. Furthermore, the insulating layers each having a low dielectric constant and the insulating layers each having a higher dielectric constant than the aforesaid insulating layers, are collectively referred to as the insulating layers 2, or as a laminate part. As described above, it is preferable that the difference in the dielectric constant between the layers contact with each other among the insulating layers be 0.2 or greater with respect to the lower layer. If the dielectric constant of the layers as a whole is too high, partial discharge occurs even if the dielectric breakdown voltage is high. Resultantly, the resin is deteriorated, and it may not be said that the dielectric strength is sufficient. The dielectric breakdown voltage of the insulated wire of the present invention is preferably 9.0 kV or higher, as determined by the twisted pair method described in the examples given below.

For example, in the case of an insulated wire using a polyamideimide in the coating layer, conventionally use is made of an insulated wire with a dielectric constant of 4.0 and a thickness of the coating layer of about 40 μm. If the dielectric constant of the coating resin is lowered just by 0.2 to 3.8, by using the structure of the present invention, the thickness of the coating layer that can be reduced to the extent that the partial discharge initiating voltage is maintained at the similar level is 5%. That is, the thickness of the coating layer can be reduced by 2.0 μm. Based on this, the size of the wire after coil-forming can be reduced to a large extent. General insulated wires having coating layers of polyamideimide are produced by, for example, stacking a polyamideimide layer with a thickness of 2 μm per layer. When the dielectric constant is lowered by 0.2, an excellent effect is exhibited, in which the number of repeated coatings of polyamideimide can be reduced by one time.

As shown in FIG. 2(b), the insulated wire of the present invention may have, on the insulating layer 24 (X2′) high in a dielectric constant, an insulating layer 31 (Y1′) lower in a dielectric constant than the insulating layer 24 (X2′) and an insulating layer 32 (Y2′) higher in a dielectric constant than the insulating layer 31 (Y1′) alternately formed. In this case, the insulating layer 31 and the insulating layer 32 constitute a third laminate unit. As such, when a large number of lamination of layers of the layer high in a dielectric constant and the layer low in a dielectric constant is employed, an insulated wire having a high dielectric breakdown voltage can be obtained. Although the reason is not clarified yet, it is presumed that dielectric breakdown of a dielectric is caused by the avalanche effect of electrons, and such an effect is sustained, by laminating layers, as the phenomenon is enhanced in which as the thickness of the insulator which is the coating layer of an enameled wire is smaller, the dielectric breakdown voltage per unit thickness is enhanced. The number of laminations of the layers of the layer high in a dielectric constant and the layer low in a dielectric constant is preferably 2 to 30, and more preferably 2 to 15. If the number of laminations of the layers is too large, a problem of poor operating efficiency occurs.

Furthermore, as shown in FIG. 2(c), on the insulating layer 24 (X2′) high in a dielectric constant, the insulating layer 31 (Y1′) lower in a dielectric constant than the insulating layer 24 (X2′) and the insulating layer 32 (Y2′) higher in a dielectric constant than the insulating layer 31 (Y1′) may be formed. Moreover, in the same manner, insulating layers low in a dielectric constant (33, 35, 37) and insulating layers high in a dielectric constant (34, 36, 38) may be formed, respectively, alternately. In this case, there are provided six laminate units in total.

In the insulated wire of the present invention, the insulating layers having a low dielectric constant in the laminate units, e.g. the insulating layer (X1) and the insulating layer (X1′), are preferably composed of at least one selected from a polyetherimide, a polyethersulfone, a polyphenyleneether, a polyphenylsulfone, and a polyimide. As the polyetherimide, use may be made, for example, of ULTEM (manufactured by GE Plastics Corp., trade name). As the polyethersulfone, use may be made, for example, of SUMIKAEXCEL PES (manufactured by Sumitomo Chemical Co., Ltd., trade name), PES (manufactured by Mitsui Chemicals, Inc., trade name), ULTRAZONE E (manufactured by BASF Japan, Ltd., trade name), and RADEL A (manufactured by Solvay Advanced Polymers, LLC, trade name). As the polyphenyleneether, use may be made, for example, of XYRON (manufactured by Asahi Kasei Chemicals Corporation, trade name) and IUPIACE (manufactured by Mitsubishi Engineering Plastics Corp., trade name). As the polyphenylsulfone, use may be made, for example, of RADEL R (manufactured by Solvay Advanced Polymers, LLC., trade name). As the polyimide, use may be made, for example, of U-VARNISH (manufactured by Ube Industries, Ltd., trade name), HCl series (manufactured by Hitachi Chemical Co., Ltd., trade names), U IMIDE (manufactured by Unitika, Ltd., trade name), and AURUM (manufactured by Mitsui Chemicals, Inc., trade name). The dielectric constant of the respective resin of those is the polyetherimide (dielectric constant: 3.2 to 3.4), the polyethersulfone (dielectric constant: 3.5), the polyphenyleneether (dielectric constant: 2.7), the polyphenylsulfone (dielectric constant: 3.4), and the polyimide (dielectric constant: 3.5), and the dielectric constant is low. However, although the dielectric breakdown voltage of any of those resins singly is low, when any of these resins is combined with the resin to be used in the insulating layer (X2) and the insulating layer (X2′) that will be described later, an insulated wire low in a dielectric constant and high in a dielectric breakdown voltage can be obtained.

The dielectric constant can be lowered, by further foaming the insulating layers having a low dielectric constant in the respective laminate units, such as the insulating layer (X1) and the insulating layer (X1′), by using at least one selected from a polyetherimide, a polyethersulfone, a polyphenyleneether, a polyphenylsulfone, and a polyimide.

In the insulated wire of the present invention, it is preferable that the insulating layers having a high dielectric constant in the respective laminate units, such as the insulating layer (X2) and the insulating layer (X2′), contain a polyamideimide. When these insulating layers contain a polyamideimide, an insulated wire having heat resistance and processability can be obtained.

More preferably, in the insulated wire of the present invention, the insulating layers having a high dielectric constant in the respective laminate units, such as the insulating layer (X2) and the insulating layer (X2′), are preferably composed of a resin composition containing a polyamideimide, and further containing at least one selected from a polyetherimide, a polyethersulfone, a polyphenyleneether, a polyphenylsulfone, and a polyimide. When using a resin composition containing a polyamideimide as an essential resin component, and also containing at least one selected from a polyetherimide, a polyethersulfone, a polyphenyleneether, a polyphenylsulfone, and a polyimide, an insulating material excellent in the heat resistance and low in a dielectric constant can be obtained. Among the resin components of the resin composition, the content of a polyamideimide is preferably 20 to 100 mass %, and more preferably 60 to 90 mass %. If the content of a polyamideimide is too small, solvent resistance and heat resistance deteriorate, and if the content is too large, the effect of lowering the dielectric constant may not be sufficiently obtained.

As the polyamideimide, use may be made, for example, of VIROMAX (manufactured by Toyobo Co., Ltd., trade name), TAURON (manufactured by Solvay Advanced Polymers, LLC, trade name), and HI-400, HI-405, and HI-406 series (manufactured by Hitachi Chemical Co., Ltd., trade names). As the polyetherimide, use may be made, for example, of ULTEM (manufactured by GE Plastics Corp., trade name). As the polyethersulfone, use may be made, for example, of SUM IKAEXCEL PES (manufactured by Sumitomo Chemical Co., Ltd., trade name), PES (manufactured by Mitsui Chemicals, Inc., trade name), ULTRAZONE E (manufactured by BASF Japan, Ltd., trade name), and VERADEL (manufactured by Solvay Advanced Polymers, LLC, trade name). As the polyphenyleneether, use may be made, for example, of XYRON (manufactured by Asahi Kasei Chemicals Corporation, trade name), and IUPIACE (manufactured by Mitsubishi Engineering Plastics Corp., trade name). As the polyphenylsulfone, use may be made, for example, of RADEL R (manufactured by Solvay Advanced Polymers, LLC., trade name). As the polyimide, use may be made, for example, of U-VARNISH (manufactured by Ube Industries, Ltd., trade name), HCl series (manufactured by Hitachi Chemical Co., Ltd., trade names), U IMIDE (manufactured by Unitika, Ltd., trade name), and AURUM (manufactured by Mitsui Chemicals, Inc., trade name).

Generally, amorphous resins, such as polyetherimides and polyethersulfones, lack chemical resistance, and are apt to deteriorate electrical characteristics, by causing cracks in the insulating layers when an insulated wire is subjected to a coil-forming and immersing the resultant coil in a varnish. Although the cause for this is not clarified yet, the occurrence of cracks can be presumed as a phenomenon, in which, as a chemical penetrates into a resin where a residual stress exists, and the polymer chains can easily move about, consequently the stress is locally relaxed, to cause cracks to occur in the layers. For example, when a coil is formed by winding an insulated wire, the resultant coil is immersed in an immersing varnish, such as an epoxy resin, and then the thus-immersed varnish is cured, cracks are apt to occur as a result of the penetration of the immersed varnish.

On the contrary, since the insulating layers having a high dielectric constant in the respective laminate units, such as the insulating layer (X2) and the insulating layer (X2′), particularly the insulating layer of the outermost layer, are composed of a resin composition containing a polyamideimide, and further containing at least one selected from a polyetherimide, a polyethersulfone, a polyphenyleneether, a polyphenylsulfone, and a polyimide, solvent resistance can be enhanced.

As the resin composition constituting the insulating layers having a low dielectric constant in the respective laminate units, such as the insulating layer (X1) and the insulating layer (X1′), use may be made of one containing a polyamideimide as a resin component, and also containing at least one selected from the group consisting of a polyetherimide, a polyethersulfone, a polyphenyleneether, a polyphenylsulfone, and a polyimide. In this case, as the resin composition constituting the insulating layers having a low dielectric constant in the respective laminate units, such as the insulating layer (X1) and the insulating layer (X1′), it is preferable to use a resin composition containing 5 to 70 mass % of a polyamideimide as a resin component, and also containing 95 to 30 mass % of at least one selected from the group consisting of a polyetherimide, a polyethersulfone, a polyphenyleneether, a polyphenylsulfone, and a polyimide. By using the resin composition of this constitution, the dielectric constant can be maintained low, without lowering the dielectric breakdown voltage. Although the dielectric constant of a polyamideimide is 4.0, the dielectric constant can be maintained low, by using a resin composition containing a polyamideimide mixed with at least one selected from the group consisting of a polyetherimide, a polyethersulfone, a polyphenyleneether, a polyphenylsulfone, and a polyimide. Furthermore, since a polyamideimide is excellent in the characteristics such as heat resistance and solvent resistance, by using this resin composition, an effect is exhibited to prevent cracks from being occurred upon a high-temperature curing of the immersed varnish.

Among the resin components of the resin composition constituting the resin layers having a low dielectric constant in the respective laminate units, such as the insulating layer (X1) and the insulating layer (X1′), it is more preferable that the content of the polyamideimide be 10 to 60 mass %, and the content of the at least one selected from the group consisting of a polyetherimide, a polyethersulfone, a polyphenyleneether, a polyphenylsulfone, and a polyimide be 90 to 40 mass %. If the content of the polyetherimide, polyethersulfone, polyphenyleneether, polyphenylsulfone, and polyimide is too small, the lowering of the dielectric constant is small. If the content of those is too large, the solvent resistance is deteriorated, and the dielectric breakdown voltage is lowered.

As the polyamideimide, use may be made, for example, of VIROMAX (manufactured by Toyobo Co., Ltd., trade name), TAURON (manufactured by Solvay Advanced Polymers, LLC, trade name), and HI-400, HI-405, and HI-406 series (manufactured by Hitachi Chemical Co., Ltd., trade names). As the polyetherimide, use may be made, for example, of ULTEM (manufactured by GE Plastics Corp., trade name). As the polyethersulfone, use may be made, for example, of SUMIKAEXCEL PES (manufactured by Sumitomo Chemical Co., Ltd., trade name), PES (manufactured by Mitsui Chemicals, Inc., trade name), ULTRAZONE E (manufactured by BASF Japan, Ltd., trade name), and VERADEL (manufactured by Solvay Advanced Polymers, LLC, trade name). As the polyphenyleneether, use may be made, for example, of XYRON (manufactured by Asahi Kasei Chemicals Corporation, trade name), and IUPIACE (manufactured by Mitsubishi Engineering Plastics Corp., trade name). As the polyphenylsulfone, use may be made, for example, of RADEL R (manufactured by Solvay Advanced Polymers, LLC., trade name). As the polyimide, use may be made, for example, of U-VARNISH (manufactured by Ube Industries, Ltd., trade name), HCl series (manufactured by Hitachi Chemical Co., Ltd., trade names), U IMIDE (manufactured by Unitika, Ltd., trade name), and AURUM (manufactured by Mitsui Chemicals, Inc., trade name).

In the present invention, in the insulating layers having a low dielectric constant in the respective laminate units, such as the insulating layer (X1) and the insulating layer (X1′), a polyimide having a dielectric constant which is lower than usual polyimides (hereinafter, also referred to as low-dielectric constant polyimide, or low-dielectric constant PI) can be used, instead of the polyimide described above. This low-dielectric constant polyimide can be obtained through an imidation reaction between a predetermined amine component and a predetermined acid component. Herein, examples of the amine component that can be used include 2,2-bis[4-[4-aminophenoxy]phenyl]propane, 4,4′-oxydianiline, p-phenylenediamine, 4,4′-diaminobenzophenone, 4,4′-bis(4-aminophenyl)sulfide, 1,4-bis(4-aminophenoxy)benzene, and 4,4′-bis(4-aminophenoxy)biphenyl. Furthermore, for the amine components, there are no particular limitations on the combination of the components, and the single component may be used, or alternatively a mixture of plural kinds of those may be used. On the other hand, examples of the acid component that can be used include 5,5′41-methyl-1,1-ethanediyl-bis(1,4-phenylene)bisoxy]bis(isobenzofuran-1,3-dione), pyromellitic anhydride, oxydiphthalic dianhydride, biphenyl-3,4,3′,4′-tetracarboxylic acid dianhydride, benzophenone-3,4,3′,4′-tetracarboxylic acid dianhydride, and 4,4′-(2,2-hexafluoroisopropylidene)diphthalic anhydride. For the acid components, there are no particular limitations on the combinations of the components, and the single component may be used, or alternatively a mixture of plural kinds of those may be used.

As the low-dielectric constant polyimide, a preferable compound is one having many non-polar hydrocarbon moieties in the structure.

The dielectric constant of the low-dielectric constant polyimide is about 2.8, and this is lower by 3.5 than the dielectric constant of usual polyimides.

Since low-dielectric constant polyimides are generally poorer in the heat resistance and solvent resistance than usual polyimides. Thus, when enameled wires are composed of low-dielectric constant polyimides only, the resultant enameled wires do not exhibit excellent characteristics. The inventors of the present invention found that, when the insulating layer low in a dielectric constant is composed of a low-dielectric constant polyimide, while the insulating layer high in a dielectric constant is composed of a polyamideimide, a polyimide, or the like, each having excellent heat resistance and solvent resistance, to combine these two insulating layers as a laminate unit, and two or more such laminate units are laminated on a conductor, the resultant insulated wire exhibits high heat resistance and high solvent resistance, even one of the insulating layers formed includes the low-dielectric constant polyimide.

In the insulating layers of the insulated wire of the present invention, use may be made of a resin composition which contains any of various additives, for example, colorants including pigments and dyes, inorganic or organic fillers, and lubricating agents, to the extent that the intended effect of the present invention is not impaired. As described above, the insulated wire may have the adherent layer (primer layer) on the conductor, and may have the surface lubricating layer or the abrasion resistant layer, as the outermost layer (topcoat) of the insulating layers. The surface lubricating layer is not particularly limited, but, for example, liquid paraffin, solid paraffin, or the like can be applied, or a layer of a lubricating agent, such as any of various waxes, polyethylenes, and fluororesins, can be formed on the outermost layer of the insulating layers. As the abrasion resistant layer, a layer of a mixture prepared by incorporating an inorganic filler, such as silicon oxide, titanium oxide, zirconia, or alumina, filled into any of various resins, such as a polyamideimide resin, a polyimide resin, and a polyesterimide resin, may be formed on the outermost layer of the insulating layers.

Herein, there are no particular limitations on the thickness of the adherent layer, but the thickness can be set to, for example, 3 to 9 μm. Furthermore, there are no particular limitations on the thickness of the topcoat, but the thickness can be set to, for example, 2 to 8 μm.

The method for producing the insulated wire of the present invention is described, with reference to FIG. 1. For example, the resin composition above is used as the resin composition to constitute the insulating layer 21 around the conductor, to form the insulating layer 21 by appropriately repeating coating and drying. Then, the insulating layers 22 to 24 are further formed in the same manner, to thereby obtain a target insulated wire. The thus-obtained insulated wire may be further processed, by bundling up a plurality of the insulated wires, followed by coating these together, to form a single insulated wire (multicore wire).

### EXAMPLES

The present invention will be described in more detail based on examples given below, but the invention is not meant to be limited by these.

The inventors of the present invention produced insulated wires having the structures shown in Tables 1 to 4, and evaluated the characteristics and properties of the insulated wires. The insulated wires of Examples 1 to 13 and Comparative Examples 1 to 4 were each obtained, by alternately laminating the insulating layer low in a dielectric constant and the insulating layer high in a dielectric constant, as shown in Tables 1 to 4, on a copper conductor with diameter 1 mm, in the number of repetitions shown in Tables 1 to 4, to thereby form the insulating layers with the respective thickness shown in Tables 1 to 4. Herein, in Examples 1 to 10, Example 13, and Comparative Example 3, the insulated wires produced had an adherent polyamideimide layer composed of HI-406 series (manufactured by Hitachi Chemical Co., Ltd., trade name) around the conductor, as shown in Tables 1 to 4. The thus-obtained insulated wires were evaluated for the following items. Furthermore, in Examples 1 to 10, Example 12, and Comparative Example 3, the insulated wires produced had a topcoat composed of a lubricating polyamideimide, AIB-SL3 (manufactured by Furukawa Electric Co., Ltd., trade name).

In Examples 1 to 13 and Comparative Examples 1 to 4, the following resins were used as the resins constituting the insulating layers. In the case of using compositions by mixing the resins, resin compositions at the mass ratios shown in Tables 1 to 4 were used.

(1) PEI; Polyetherimide (ULTEM (trade name, manufactured by GE Plastics))
(2) PES; Polyethersulfone (SUMIKAEXCEL PES (trade name, manufactured by Sumitomo Chemical Co., Ltd.))
(3) PI; Polyimide (U-IMIDE (trade-name, manufactured by UNITIKA Ltd.))
(4) PAI; Polyamideimide (HI-406 series (trade name, manufactured by Hitachi Chemical Co., Ltd.))
(5) PPSU; Polyphenylsulfone (RADEL R(trade name, manufactured by Solvay Advanced Polymers))
(6) PPE; Polyphenyleneether (XYRON (trade name, manufactured by Asahi Kasei Chemicals Corp.))

### <Preparation of Low-Dielectric Constant Polyimide>

In Examples 14 and 15, insulated wires were produced in the same manner as in the preparation of the insulated wires of Examples 1 to 13, except for utilizing the low-dielectric constant polyimide (low-dielectric constant PI (low-∈PI)) as shown in Table 3, which had been prepared as described below.

That is, to a 500-mL flask, 395 g of N-methyl-2-pyrrolidone, 47.94 g (0.117 mol) of 2,2-bis[4-[4-aminophenoxy]phenyl]propane, and 57.06 g (0.117 mol) of 5,5′-[1methyl-1,1-ethanediyl-bis(1,4-phenylene)bisoxy]bis(isobenzofuran-1,3-dione) were placed, followed by allowing to undergo a reaction by stirring the resultant mixture for 12 hours at room temperature under a nitrogen atmosphere, to obtain the low-dielectric constant polyimide.

The thus-prepared low-dielectric constant polyimide was used in the varnish to be used in the formation of the insulating layers (X1), (X1′), and the like, having a low dielectric constant, followed by baking the varnish (applying and drying), to obtain the insulated wires of Examples 14 and 15.

### [Dielectric Constant]

For the dielectric constant, the electrostatic capacity of the resultant respective enameled wire was measured, and the dielectric constant obtained from the electrostatic capacity and the thickness of the insulating layer was taken as the measured value. For the measurement of the electrostatic capacity, LCR HITESTER (manufactured by Hioki E.E. Corp., Model 3532-50) was used. The measurement temperature was set to 25° C., and the measurement frequency was set to 50 Hz. A dielectric constant of 3.9 or less was judged to pass the test criteria.

### [Dielectric Breakdown Voltage]

The dielectric breakdown voltage was measured in accordance with the twisted pair method. A dielectric breakdown voltage of 9.0 kV or higher was judged to pass the test criteria.

### (Twisted Pair Method)

Two of any of the insulated wires were twisted together, and an alternating current voltage with sine wave at frequency 50 Hz was applied between the conductors. While the voltage was continuously increased, the voltage (effective value) at which the dielectric voltage occurred, was measured. The measurement temperature was set at 25° C.

### [Solvent Resistance]

The insulated wire in a length of 50 cm was wound around a bar with diameter 50 mm, and the resultant wire wound around the bar was immersed in cresol for one hour at room temperature. Then, the bar with the wire was taken out, and the surface of the resultant insulated wire was observed. Based on the outer appearance, a sample caused no cracks was judged to pass the test criteria, and the sample passed is rated as “∘” (good) in Tables 1 to 4, while a sample failed to pass the test criteria is rated as “x” (poor) in Tables 1 to 4.

The evaluation results of the insulated wires obtained in Examples 1 to 15 and Comparative Examples 1 to 4 are shown in Tables 1 to 4.

TABLE 1

| | Ex 1 | Ex 2 | Ex 3 | Ex 4 | Ex 5 |
|---|---|---|---|---|---|
| Insulating layers low in a dielectric constant (X1, | PEI | PEI | PEI | PEI | PEI |
| X1′) | | | | | |
| Insulating layers high in a dielectric constant (X2, | PAI | PAI | PAI | PAI | PEI + PAI |
| X2′) | | | | | (PEI:PAI = 5:5) |
| Laminate units (number) | 6 | 5 | 3 | 2 | 5 |
| Thickness of the adherent layer (μm) | 2 | 2 | 2 | 2 | 2 |
| Thickness of the laminate parts (μm) | 26 | 26 | 26 | 26 | 26 |
| Thickness of the topcoat (μm) | 2 | 2 | 2 | 2 | 2 |
| Overall thickness of the insulating layers (μm) | 30 | 30 | 30 | 30 | 30 |
| Dielectric breakdown voltage (kV) | 11.4 | 11.7 | 10.4 | 10.1 | 10.4 |
| Solvent resistance | ∘ | ∘ | ∘ | ∘ | ∘ |
| Resin utilized in the insulating layers low in a | PEI | PEI | PEI | PEI | PEI |
| dielectric constant (X1, X1′) | | | | | |
| Dielectric constant | 3.3 | 3.3 | 3.3 | 3.3 | 3.3 |
| Resin utilized in the insulating layers high in a | PAI | PAI | PAI | PAI | PEI + PAI |
| dielectric constant (X2, X2′) | | | | | (PEI:PAI = 5:5) |
| Dielectric constant | 4.0 | 4.0 | 4.0 | 4.0 | 3.7 |
| Dielectric constant of the materials of the adherent | 4.0 | 4.0 | 4.0 | 4.0 | 4.0 |
| layer & topcoat | | | | | |
| Sum total of the thickness of the insulating layers low | 13 | 13 | 13 | 13 | 19.5 |
| in a dielectric constant (X1, X1′) (μm) | | | | | |
| Sum total of the thickness of the insulating layers high | 13 | 13 | 13 | 13 | 6.5 |
| in a dielectric constant (X2, X2′) (μm) | | | | | |
| Sum total of the thickness of the adherent layer & | 4 | 4 | 4 | 4 | 4 |
| topcoat (μm) | | | | | |
| Dielectric constant of the overall coatings of the | 3.7 | 3.7 | 3.7 | 3.7 | 3.5 |
| adherent layer, insulating layers, and topcoat | | | | | |

“Ex” means Example according to the present invention.

TABLE 2

| | Ex 6 | Ex 7 | Ex 8 | Ex 9 | Ex 10 |
|---|---|---|---|---|---|
| Insulating layers low in a dielectric constant (X1, | PES | PPE + PAI | PI | PEI | PEI |
| X1′) | | (PPE:PAI = 5:5) | | | |
| Insulating layers high in a dielectric constant (X2, | PAI | PAI | PEI + PAI | PPSU + PAI | PES + PAI |
| X2′) | | | (PEI:PAI = 5:5) | (PPSU:PAI = 2:8) | (PES:PAI = 5:5) |
| Laminate units (number) | 5 | 5 | 5 | 5 | 5 |
| Thickness of the adherent layer (μm) | 2 | 2 | 2 | 2 | 2 |
| Thickness of the laminate parts (μm) | 26 | 26 | 26 | 26 | 26 |
| Thickness of the topcoat (μm) | 2 | 2 | 2 | 2 | 2 |
| Overall thickness of the insulating layers (μm) | 30 | 30 | 30 | 30 | 30 |
| Dielectric breakdown voltage (kV) | 11.5 | 11.4 | 11.0 | 10.8 | 11.2 |
| Solvent resistance | ∘ | ∘ | ∘ | ∘ | ∘ |
| Resin utilized in the insulating layers low in a | PES | PPE + PAI | PI | PEI | PEI |
| dielectric constant (X1, X1′) | | (PPE:PAI = 5:5) | | | |
| Dielectric constant | 3.5 | 3.4 | 3.5 | 3.3 | 3.3 |
| Resin utilized in the insulating layers high in a | PAI | PAI | PEI + PAI | PPSU + PAI | PES + PAI |
| dielectric constant (X2, X2′) | | | (PEI:PAI = 5:5) | (PPSU:PAI = 2:8) | (PES:PAI = 5:5) |
| Dielectric constant | 4.0 | 4.0 | 3.7 | 3.7 | 3.8 |
| Dielectric constant of the materials of the adherent | 4.0 | 4.0 | 4.0 | 4.0 | 4.0 |
| layer & topcoat | | | | | |
| Sum total of the thickness of the insulating layers low | 13 | 6.5 | 19.5 | 19.5 | 19.5 |
| in a dielectric constant (X1, X1′) (μm) | | | | | |
| Sum total of the thickness of the insulating layers high | 13 | 19.5 | 6.5 | 6.5 | 6.5 |
| in a dielectric constant (X2, X2′) (μm) | | | | | |
| Sum total of the thickness of the adherent layer & | 4 | 4 | 4 | 4 | 4 |
| topcoat (μm) | | | | | |
| Dielectric constant of the overall coatings of the | 3.8 | 3.7 | 3.6 | 3.6 | 3.6 |
| adherent layer, insulating layers, and topcoat | | | | | |

“Ex” means Example according to the present invention.

TABLE 3

| | Ex 11 | Ex 12 | Ex 13 | Ex 14 | Ex 15 |
|---|---|---|---|---|---|
| Insulating layers low in a dielectric constant (X1, | PEI | PEI | PEI | Low-∈ PI | Low-∈ PI |
| X1′) | | | | | |
| Insulating layers high in a dielectric constant (X2, | PAI | PAI | PEI + PAI | PAI | PI |
| X2′) | | | (PEI:PAI = 5:5) | | |
| Laminate units (number) | 5 | 5 | 5 | 5 | 5 |
| Thickness of the adherent layer (μm) | — | — | 2 | — | — |
| Thickness of the laminate parts (μm) | 30 | 28 | 28 | 30 | 30 |
| Thickness of the topcoat (μm) | — | 2 | — | — | — |
| Overall thickness of the insulating layers (μm) | 30 | 30 | 30 | 30 | 30 |
| Dielectric breakdown voltage (kV) | 11.5 | 11.6 | 10.5 | 11.2 | 11.3 |
| Solvent resistance | ∘ | ∘ | ∘ | ∘ | ∘ |
| Resin utilized in the insulating layers low in a | PEI | PEI | PEI | Low-∈ PI | Low-∈ PI |
| dielectric constant (X1, X1′) | | | | | |
| Dielectric constant | 3.3 | 3.3 | 3.3 | 2.9 | 2.9 |
| Resin utilized in the insulating layers high in a | PAI | PAI | PEI + PAI | PAI | PI |
| dielectric constant (X2, X2′) | | | (PEI:PAI = 5:5) | | |
| Dielectric constant | 4.0 | 4.0 | 3.7 | 4.0 | 3.5 |
| Dielectric constant of the materials of the adherent | 4.0 | 4.0 | 4.0 | — | — |
| layer & topcoat | | | | | |
| Sum total of the thickness of the insulating layers low | 15 | 14 | 14 | 15 | 15 |
| in a dielectric constant (X1, X1′) (μm) | | | | | |
| Sum total of the thickness of the insulating layers high | 15 | 14 | 14 | 15 | 15 |
| in a dielectric constant (X2, X2′) (μm) | | | | | |
| Sum total of the thickness of the adherent layer & | 0 | 2 | 2 | 0 | 0 |
| topcoat (μm) | | | | | |
| Dielectric constant of the overall coatings of the | 3.6 | 3.7 | 3.7 | 3.4 | 3.2 |
| adherent layer, insulating layers, and topcoat | | | | | |

“Ex” means Example according to the present invention.

TABLE 4

| | C Ex 1 | C Ex 2 | C Ex 3 | C Ex 4 |
|---|---|---|---|---|
| Insulating layers low in a dielectric constant (X1, | PEI | — | PEI | PI |
| X1′) | | | | |
| Insulating layers high in a dielectric constant (X2, | — | PAI | PAI | PEI + PAI |
| X2′) | | | | (PEI:PAI = 5:5) |
| Laminate units (number) | 0 | 0 | 1 | 1 |
| Thickness of the adherent layer (μm) | — | — | 2 | — |
| Thickness of the laminate parts (μm) | 30 | 30 | 26 | 30 |
| Thickness of the topcoat (μm) | — | — | 2 | — |
| Overall thickness of the insulating layers (μm) | 30 | 30 | 30 | 30 |
| Dielectric breakdown voltage (kV) | 8.2 | 12.0 | 8.8 | 7.5 |
| Solvent resistance | x | ∘ | ∘ | x |
| Resin utilized in the insulating layers low in a | PEI | — | PEI | PI |
| dielectric constant (X1, X1′) | | | | |
| Dielectric constant | 3.3 | — | 3.3 | 3.5 |
| Resin utilized in the insulating layers high in a | — | PAI | PAI | PEI + PAI |
| dielectric constant (X2, X2′) | | | | (PEI:PAI = 5:5) |
| Dielectric constant | — | 4.0 | 4.0 | 3.7 |
| Dielectric constant of the materials of the adherent | — | — | 4.0 | — |
| layer & topcoat | | | | |
| Sum total of the thickness of the insulating layers low | 30 | 0 | 13 | 6 |
| in a dielectric constant (X1, X1′) (μm) | | | | |
| Sum total of the thickness of the insulating layers high | 0 | 30 | 13 | 24 |
| in a dielectric constant (X2, X2′) (μm) | | | | |
| Sum total of the thickness of the adherent layer & | 0 | 0 | 4 | 0 |
| topcoat (μm) | | | | |
| Dielectric constant of the overall coatings of the | 3.3 | 4.0 | 3.7 | 3.7 |
| adherent layer, insulating layers, and topcoat | | | | |

“C Ex” means Comparative Example.

As can be seen from Tables 1 to 4, the insulated wires of Examples 1 to 15 exhibited excellent results in terms of the dielectric constant, the dielectric breakdown voltage, and the solvent resistance. Contrary to the above, the insulated wire which had only a polyetherimide layer, was low in the dielectric constant, but the withstand voltage (dielectric breakdown voltage) and solvent resistance were not at the level passing the test criteria (Comparative Example 1). Further, the insulated wire which had only a polyamideimide layer, was high in the withstand voltage (dielectric breakdown voltage), but since the dielectric constant was high, the insulated wire was not at the level passing the test criteria (Comparative Example 2). Further, as shown in Comparative Example 3, even if a polyetherimide was used as the layer low in a dielectric constant, and a polyimide was used as the layer high in a dielectric constant, when there was only one laminate unit, the dielectric constant was at a level passing the test criteria, but the dielectric breakdown voltage was not at the level passing the test criteria. Further, Comparative Example 4 was a test example simulating Example 12 described in the above-described Patent Literature 3 (JP-A-2001-155551). However, as shown in Table 4, even if a varnish of a polyimide was used as the layer low in a dielectric constant, and a varnish composed of a polyetherimide and a polyamideimide was used as the layer high in a dielectric constant, when there was only one laminate unit, the dielectric constant was at a level passing the test criteria, but the insulated wire was poor in the solvent resistance, and the dielectric breakdown voltage was not at the level passing the test criteria.

Having described our invention as related to the present embodiments, it is our intention that the invention not be limited by any of the details of the description, unless otherwise specified, but rather be construed broadly within its spirit and scope as set out in the accompanying claims.

This non-provisional application claims priority under 35 U.S.C. §119 (a) on Patent Application No. 2010-224337 filed in Japan on Oct. 1, 2010, which is entirely herein incorporated by reference.

### REFERENCE SIGNS LIST

1 Conductor
2 Insulating layers
11 Adherent layer
21 First insulating layer (X1)
22 Insulating layer (X2) higher in a dielectric constant than the first insulating layer (X1)
23 First insulating layer (X1′)
24 Insulating layer (X2′) higher in a dielectric constant than the first insulating layer (X1′)
31 First insulating layer (Y1′)
32 Insulating layer (Y2′) higher in a dielectric constant than the first insulating layer (Y1′)
33, 35, 37 Insulating layers low in a dielectric constant
34, 36, 38 Insulating layers high in a dielectric constant
41 Topcoat

1. An insulated wire, having directly or indirectly on a conductor, at least two laminate units each formed by laminating a first insulating layer and a second insulating layer higher in a dielectric constant than the first insulating layer, in this order from the conductor side.

2. The insulated wire according to claim 1, in which the dielectric constant of the second insulating layer in one laminate unit is higher than the dielectric constant of the first insulating layer in another laminate unit that is positioned on the outer layer side of the one laminate unit.

3. The insulated wire according to claim 1, in which an absolute value of a difference between the dielectric constants of two layers that are in contact with each other among the insulating layers is 0.2 or greater.

4. The insulated wire according to claim 1, in which the first insulating layers in the respective laminate units each are composed of a resin composition containing at least one selected from the group consisting of a polyetherimide, a polyethersulfone, a polyphenyleneether, a polyphenylsulfone, and a polyimide.

5. The insulated wire according to claim 1, in which the first insulating layers in the respective laminate units each are composed of a resin composition containing at least one selected from the group consisting of a polyetherimide, a polyethersulfone, a polyphenyleneether, a polyphenylsulfone, and a polyimide, and further containing a polyamideimide.

6. The insulated wire according to claim 4, in which the second insulating layers in the respective laminate units each are composed of a resin composition containing a polyamideimide.

7. The insulated wire according to claim 5, in which the second insulating layers in the respective laminate units each are composed of a resin composition containing a polyamideimide, and further containing at least one selected from the group consisting of a polyetherimide, a polyethersulfone, a polyphenyleneether, a polyphenylsulfone, and a polyimide.
